(19) United States
(12) Patent Application Publication
(10) Pub. No.: US 2003/0055925 A1
(43) Pub. Date: Mar. 20, 2003

(54) Discovering client capabilities

(76) Inventor: Paul McAlinden, Austin, TX (US)

Correspondence Address: Timothy N. Trop, TROP, PRUNER & HU, P.C., 8554 KATY FWY, STE 100, HOUSTON, TX, 77024-1805, US

(21) Appl. No.: 09/923,581

(22) Filed: Aug. 6, 2001

(51) Int. Cl. G06F 15/177; G06F 15/16; G06F 15/173; G06F 9/44; G06F 9/445

(52) U.S. Cl. 709/221; 709/224; 717/173; 717/178

(57) ABSTRACT

A network including a client and server may send capability determining software from the server to the client. At the client, the software determines the capability of each particular client, forms a message, and sends that message back to the server. Based on the message received as a result of the operation of the software, the server can better provide its services to the client in some embodiments.

### BACKGROUND

This invention relates generally to processor-based systems including personal computers, telephones, set-top boxes, and personal digital assistants, to mention a few examples.

Commonly a set of networked processor-based systems may be served by a server that provides information to and receives information from a plurality of clients in the network. A server may need to determine the current characteristics of a client in the network. This may be important to determining what software can be downloaded from the server to the client or to determine what tasks the client may be called upon to perform. For example, the server may wish to know the client's processor speed, memory size, screen size, input protocols to mention a few examples.

Conventionally, the assessment of client capabilities may be based on what is known as a classmark. Classmarks are hard-coded values that provide information about the capabilities of the client. The format, content and information conveyed by classmarks must be determined prior to deployment of the client itself.

As a result, classmarks are not amenable to changing circumstances, conditions and hardware and software environments. The types of services being deployed by a network may evolve relatively rapidly. However, the classmark scheme relies on the assumption that all relevant capabilities may be incorporated prior to the first client shipment. As a result, the classmark scheme is relatively inflexible.

Thus, there is a need for better ways to determine client capabilities in networks.

### BRIEF DESCRIPTION OF THE DRAWINGS

FIG. 1 is a schematic depiction of one embodiment of the present invention;

FIG. 2 is a flow chart for software on a server in accordance with one embodiment of the present invention; and

FIG. 3 is a flow chart for software on a client in accordance with one embodiment of the present invention.

### DETAILED DESCRIPTION

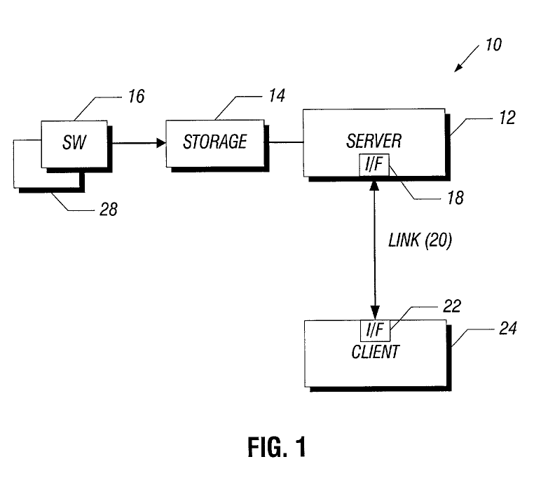

Referring to FIG. 1, a network 10 may include a server 12 coupled to a client 24 by a link 20. The link 20 may be a wired or wireless link. Suitable wired links 20 include telephone lines, optical lines, and conventional cables. Suitable wireless links 20 include radio frequency and infrared links.

While only one client 24 is illustrated, commonly a plurality of clients 24 may be coupled by one or more links 20 to the server 12. Thus, a conventional client server relationship may be established. The client server relationship may be as a conventional local area network (LAN) in one embodiment. As another embodiment, the network may be part of a telephone network. The telephone network may be circuit-based or packet-based.

Thus, in one example, the client 24 may be a particular telephone and the server 12 may be a base station. In such case, the link 20 may be a wired or wireless link depending on the type of telephone network.

The server 12 may include an interface 18 that is coupled to the link 20 as well as a storage 14 that stores software 16 and 28. Conventionally, the server 12 is processor-based, meaning that it includes at least one or more processors to implement various functions.

Similarly, the client 24 is also processor-based. The client 24 may include an interface 22 to a link 20.

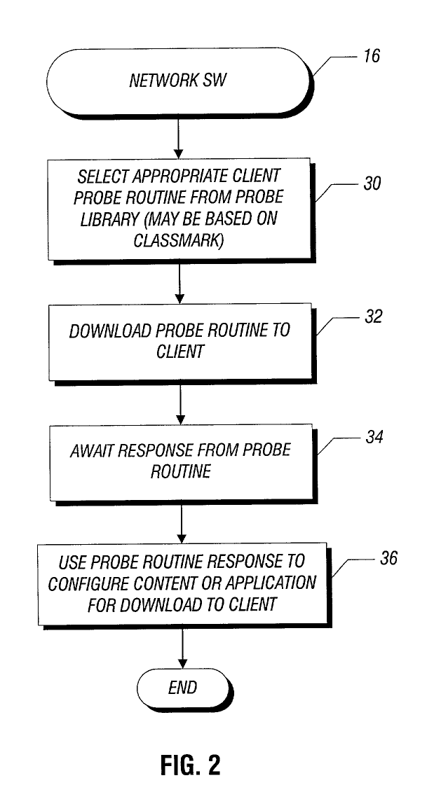

When the server 12 needs to determine the capabilities of the client 24, it may run the software 16 shown in FIG. 2 in accordance with one embodiment of the present invention. Initially, the server 12 selects an appropriate client probe routine from a probe routine library as indicated in block 30. The probe routine library may be a plurality of probe routines that may be utilized depending on the characteristics of the client 24. Thus, the server 12 applies the information it has about the client 24 in order to assess and determine the appropriate probe routine.

In one embodiment of the present invention, the classmark information may be utilized to select the appropriate probe routine. In such case, rather than using the classmark as the sole client information, the classmark is merely utilized to determine which probe routine to send to a particular client 24 as indicated in block 30.

Next, the probe routine is transferred to the client 24 over the link 20 as indicated in block 32. The server 12 then awaits a response from the probe routine at the client 24 as indicated in block 34. The probe routine response may then be used in one embodiment to configure the content or application to be downloaded to the client 22 as indicated in block 36. Thus, the probe routine may be utilized to provide services that are specifically tailored to the characteristics or capabilities of a particular client 24.

Because the probe routines are stored in the storage 14 on the server 12 in accordance with one embodiment, they can be essentially continuously updated. Thus, the probe routines may be refined to better query the client 24 given the current operating circumstances, conditions, and updates to mention a few examples. As a result, the use of the probe routine may be more flexible than the classmark scheme in some situations.

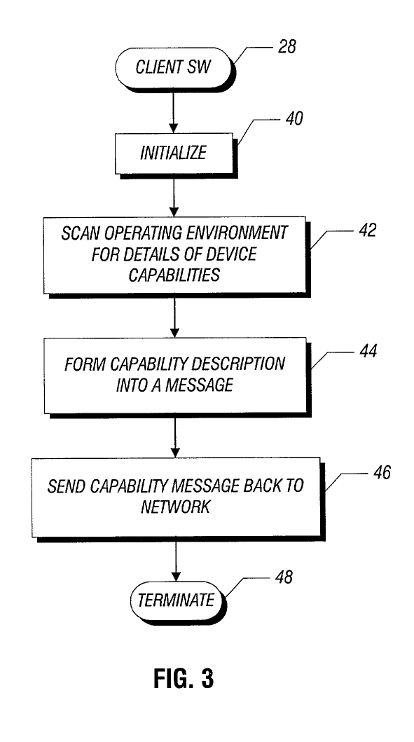

Turning next to FIG. 3, the probe routine software 28 running on the client 24 is initialized as indicated in block 40 in accordance with one embodiment of the present invention. Once the client software 28 is provided by the server 12 to the client 24, it initializes on the client 24 as indicated in block 40. The software 28 then executes on the client 24, scanning the operating environment of the client 24 for details about device capabilities as indicated in block 42. For example, the software 28 may examine various files including Registries on the client 24.

The software 28 then develops a capability description based on the information gleaned from the client 24 as indicated in block 44. That information is transformed into an appropriate message to be sent from the client 24 to the server 12. Finally, the capability message is sent by the client 24 back to the server 12 as indicated in block 46.

In one embodiment of the present invention, the software 28 may then remain resident on the client 24. Subsequently, that same software 28 may be reactivated or, if necessary, new software or updated software may be sent from the server 12 to the client 24.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
transferring software from a server to a client; and
enabling the software to determine the capabilities of the client and to provide information back to the server about those client capabilities.

2. The method of claim 1 including transferring the software over a wireless network.

3. The method of claim 1 including transferring the software over a wired network.

4. The method of claim 1 including transferring the software over a telephone network.

5. The method of claim 1 including transferring the software over a local area network.

6. The method of claim 1 including determining characteristics of the client in order to select the appropriate software to transfer from server to client.

7. The method of claim 6 including obtaining classmark information about client.

8. The method of claim 7 including using the classmark information to select software to transfer from the server to the client.

9. An article comprising a medium storing instructions that enable a processor-based system to:
transfer software from a server to a client; and
enable the software to determine the capabilities of the client and to provide information back to the server about those client capabilities.

10. The article of claim 9 further storing instructions that enable the processor-based system to transfer the software over a wireless network.

11. The article of claim 9 further storing instructions that enable the processor-based system to transfer the software over a wired network.

12. The article of claim 9 further storing instructions that enable the processor-based system to transfer the software over a telephone network.

13. The article of claim 9 further storing instructions that enable the processor-based system to transfer the software over a local area network.

14. The article of claim 9 further storing instructions that enable the processor-based system to determine a characteristic of the client in order to select the appropriate software to transfer from server to client.

15. The article of claim 14 further storing instructions that enable the processor-based system to obtain classmark information about the client.

16. The article of claim 15 further storing instructions that enable the processor-based system to use the classmark information to select software to transfer from the server to the client.

17. A system comprising:
a server;
an interface coupled to the server to enable the server to transfer software to a plurality of clients;
a storage coupled to said server, said storage storing software that includes instructions to transfer software from the server to a client and enables the software to determine the capabilities of the client and to provide information back to the server about those client capabilities.

18. The system of claim 17 including at least one client.

19. The system of claim 17 including a wireless link.

20. The system of claim 17 including a hard wired link between server and client.

21. The system of claim 17 wherein said storage stores instructions that enable the server to transfer the software over a telephone network.

22. The system of claim 17 wherein said storage stores instructions that enable the server to determine a characteristic of the client in order to select the appropriate software to transfer from server to client.

23. The system of claim 22 wherein said storage stores instructions that enable the server to obtain classmark information about the client.

24. The system of claim 23 wherein said storage stores instructions that enable the server to use the classmark information to select software to transfer from server to client.
